(19) United States
(12) Patent Application Publication
(10) Pub. No.: US 2022/0087223 A1
(43) Pub. Date: Mar. 24, 2022

(54) INTERACTIVE CAT TOY

(71) Applicant: Jared Alan Carr, Dublin, OH (US)

(72) Inventor: Jared Alan Carr, Dublin, OH (US)

(21) Appl. No.: 17/330,576

(22) Filed: May 26, 2021

Related U.S. Application Data
(60) Provisional application No. 63/081,431, filed on Sep. 22, 2020.

(51) Int. Cl. A01K 15/02; A63H 33/26

(52) U.S. Cl. CPC A01K 15/025; A63H 33/26

(57) ABSTRACT

The device of the present disclosure is most generally related to interactive pet toys, more particularly this disclosure is related to cat toys having a hanging toy within a housing. The housing having a plurality of holes or apertures that provide access to an interior space of the housing to visually trigger an instinctive response in a pet, such as a cat. The housing providing an enclosure for the placement of the hanging toy and including features to facilitate life-like, erratic, and substantially prolonged three-dimensional movement of the hanging toy through the addition of magnets, magnetic surfaces, and specifically aligned polarities of these magnets.

### CROSS-REFERENCE TO RELATED APPLICATION

This U.S. patent application claims priority to U.S. Provisional Application 63/081,431 filed Sep. 22, 2020, the disclosure of which is considered part of the disclosure of this application and is hereby incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

This invention relates generally to an interactive pet toy. More particularly, this invention relates to a pet toy for an animal, such as a cat, that provides for life like movement of a pendant that can be contacted by the animal during play.

### BACKGROUND

In the pet toy industry, there are many examples of assemblies utilizing a mechanism to dangle or entice an animal through a pendulum-like or oscillating mechanism of an object, such as a toy. The movement of this toy catches the interest of the pets, keep the pets entertained and encourage the pets to exercise.

U.S. Pat. Nos. 3,295,499, 4,011,674, 4,517,922, and 4,940,018, disclose pendulum-based toys for animals, wherein a generally flexible rod is mounted onto a base via a pole and/or a spring, a toy is suspended by the flexible rod through a string and when the hanging toy (tethered element) is battered, by the user or by the animal, a movement occurs.

U.S. Pat. No. 4,690,657 teaches a magnetically actuated pendulum-like amusement device which requires the user to provide the initial movement of the tethered member.

U.S. Pat. No. 5,119,001 teaches a pendulum-like amusement device which is gear driven to ensure that a hanging toy element continues moving after the pet stops battering the hanging toy element.

All these pet amusement devices as described above have some common disadvantages: they can be easily tipped over by the animal and the uncovered string/rod/wire used to hang or suspend the toy element can potentially wind around the animal's body parts or simply be taken down by the animal. Further, the motion generated by these devices is generally consistent and routine in nature, wherein the pet can easily loose interest due to this repetitive movement.

U.S. Pat. No. 5,148,769 provides a solution to the tipping problem by teaching a device having a suction cup, however, this device still has an uncovered spring-like wire.

U.S. Pat. No. 5,595,141 provides a solution to the motivational means by teaching a device wherein the original movement of the object is not physically initiated by the animal or human intervention, but by the device through magnetic forces. Similarly, U.S. Pat. No. 5,675,225 teaches a device wherein a battery powered motor rotates a tethered toy to attract the animal's interest. These devices attempt to exhibit features configured to attract an animal by taking advantage of the inherent instincts of an animal's response to a moving object.

It is well known that animals are very inquisitive, and cats, in particular, are highly attracted to small hollow places, such as boxes and holes. U.S. Pat. No. 6,945,195 takes advantage of this in teaching a device with toys enclosed in a housing having holes. The device of this '195 reference allows for the animal to remove the toys from within the housing. This feature, although desirable for the animal, can result in lost toys to detriment of both the workings of the device and the animal. U.S. Pat. No. 7,900,584 also takes advantage of this in teaching a device with toys enclosed within in a housing having holes for interaction. The device of this '584 patent further defines a pendulum-based hanging toy that requires the cat or another user to batter it for constant movement.

Based these deficiencies within the prior art, there exists a need for an improved device in the form of an animal amusement device that is capable of providing life like movement of an object to generate interaction by the animal and maintain the attention of the animal during playing. Preferably this device is adapted to provide enjoyment for cats during use that is durable and attractive to the cat by taking advantage of their inquisitive instinct and interest to investigate objects within holes.

Furthermore, it would be advantageous to have such an apparatus in a portable assembly. Still further, it would also be beneficial to have an apparatus that is provided in a specific structure having a plurality of magnetic objects and magnetic positioning to facilitate life like movement of a suspended object.

### BRIEF SUMMARY OF THE INVENTION

This invention advantageously fills the aforementioned deficiencies by providing an interactive toy assembly for animals, including, but not limited to, cats, which provides a safe way to stimulate interest and encourage physical activity. Among other things, it is an advantage of the invention to provide an interactive cat toy that does not suffer from any of the problems or deficiencies associated with prior solutions.

The device of the present disclosure is most generally related to interactive pet toys, more particularly this disclosure is related to cat toys having a hanging toy within a housing. The housing having a plurality of holes or apertures that provide access to an interior space of the housing to visually trigger an instinctive response in a pet, such as a cat. The housing providing an enclosure for the placement of the hanging toy and including features to facilitate life-like, erratic, and substantially prolonged three-dimensional movement of the hanging toy.

The device is preferably comprised of a cube shaped housing including a lower/floor surface coupled to corresponding sidewalls to support a top portion positioned opposed to the lower/floor surface. The device preferably constructed out of a transparent material or at least a translucent material providing for viewing of an object within the interior space of the housing to facilitate interaction.

The device is configured in an assembly that is interchangeable, portable, and reusable. The device is offered in multiple themed options and multiple materials.

In another aspect of this disclosure, the device of the present disclosure utilizes a plurality of magnet objects with specifically aligned polarities configured for assisted movement of the hanging toy enabled by these magnetic forces. This apparatus fulfills the need for self-powered cat toys to direct movement of an article without the use of a power source.

It is to be understood by one skilled in the art that the apparatus may have multiple designs and the housing may have other shapes.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a view of the front of device, according to present disclosure;

FIG. 2 is a view of the top of device, according to present disclosure;

FIG. 3 is a view of the bottom of device, according to present disclosure; and

FIG. 4 is a perspective view of device, according to present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit, or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The device of the present disclosure is most generally related to an enclosure configured to allow for the hanging of an object within an interior space from an upper pivot point, wherein the object and its motion can be manipulated from access to the interior space through a plurality of apertures by an animal for play and amusement. More particularly, the hanging object is provided with a first magnet configured for movement upon contact by an animal, such as, but not limited to a cat, between magnetic positions placed on a lower/floor surface of the device. The magnets and associated movement of the hanging object create a stimulating lure motion to encourage extended animal play.

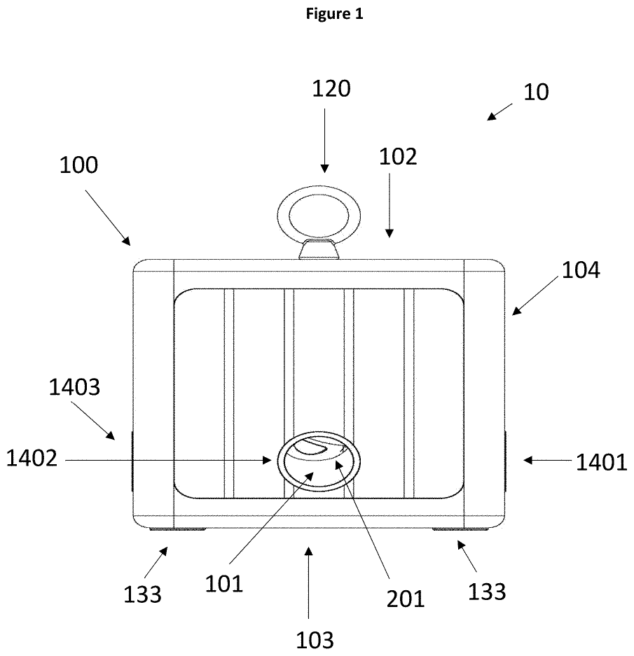

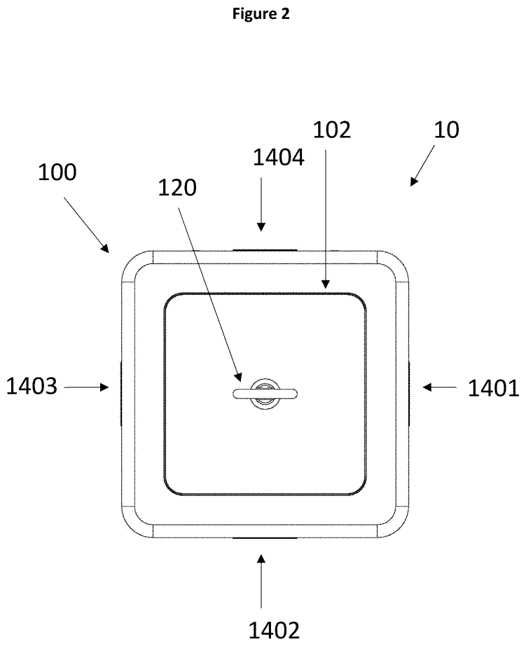

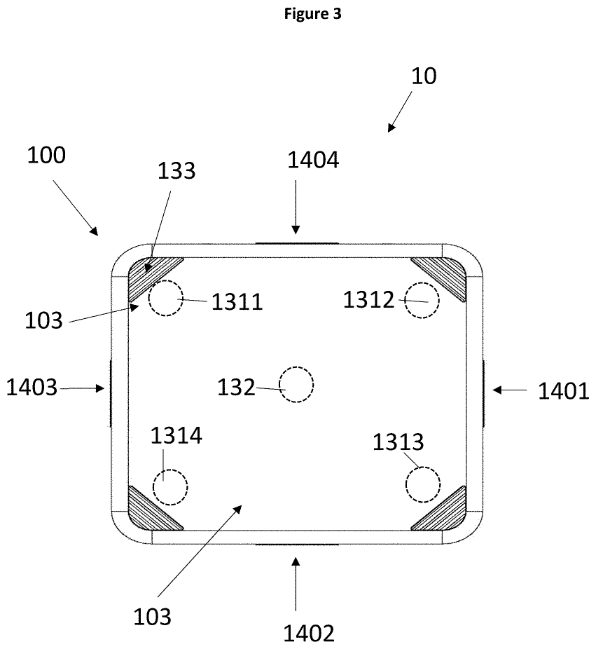

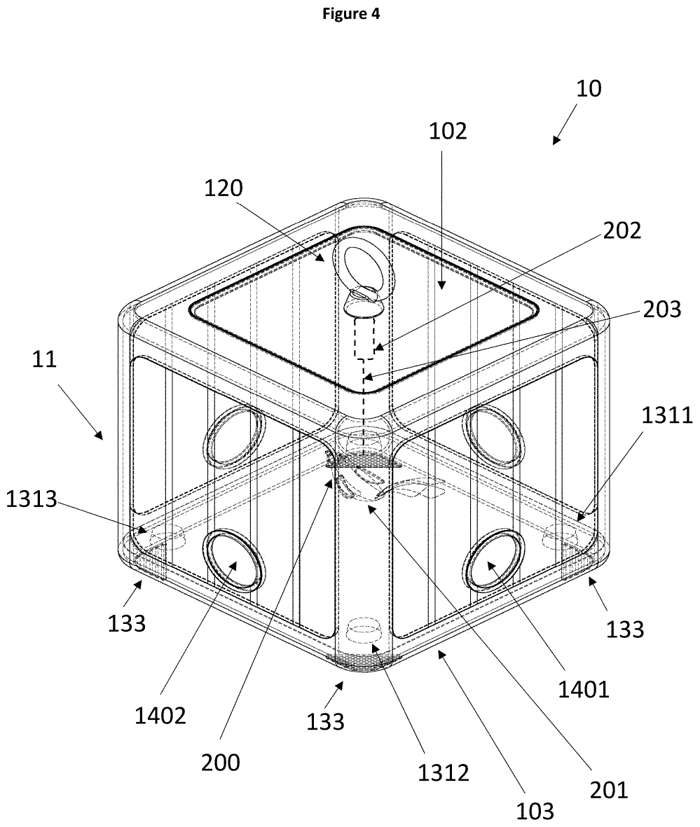

Referring to the figures, FIG. 1 to FIG. 4 show an interactive animal play toy according to the present disclosure and generally referred to as device 10. The device 10 comprises a housing 100 providing an enclosure and defining an interior space 101. The housing 100 including a top portion 102, a lower floor 103, and a plurality of sidewalls 104 coupled between the lower floor 103 and the top portion 102 to enclose and define the interior space 101. The top portion 102 configured for removal for access to the interior space 101 and equipped with a carrying handle 120 on an upper side opposite the interior space 101. The top portion 102 including a hanging toy 200 configured for hanging and dangling into the interior space 101 from a coupling with a lower side of the top portion 102 and extending towards the lower floor 103. The top portion 102 removability allows for the hanging toy 200 to be interchanged by the user, wherein the top portion 102 can be separated from the housing 100 plurality of sidewalls 104 to allow for access to the interior space 101 and the hanging toy 200.

The plurality of sidewalls 104 generally extending a height between the lower floor 103 and the top portion 102 and surrounding the interior space 101. The plurality of sidewalls 104 includes a plurality of apertures 140. The plurality of apertures 140 spaced along the sidewalls 104 and generally providing an opening from an exterior of the device 10 housing 100 to the interior space 101. Accordingly, the plurality of apertures 140 are provided in a size to allow an animal interacting with the device 10 to access the interior space 101 for contacting the hanging toy 200 during play with a paw.

The device 10 hanging toy 200 is configured for realistic and life-like movement for enticing interaction with an animal utilizing the device 10 through magnetic communication with a plurality of magnets spaced in a specific alignment along the lower floor 103. Accordingly, the hanging toy 200 includes a magnetic portion 201 generally positioned at a lowest point of the hanging toy 200 to be generally placed adjacent to the lower floor 103 to facilitate the magnetic coupling. The magnetic portion 201 selected with a specific magnetic pole to interact with the other magnets of the device 10. The lower floor 103 including the plurality of magnets in the form of edge magnets 131 positioned near the edges or corners of the lower floor 103 and a center magnet 132 generally positioned at a center of the lower floor 103 and aligned to be directly below the hanging toy 200 when the hanging toy 200 is hung from the top portion 102 and in a relaxed state.

The device 10 hanging toy 200 configured to provide quasi-perpetual functionality provided by the assisted movement from magnetic forces onto the magnetic portion 201 of the hanging toy 200, wherein this apparatus fulfills the need for a self-powered toy to direct movement of an article without the use of a power source. Accordingly, the effect of the magnets, such as the edge magnets 131 and the center magnet 132 onto the hanging toy 200 magnetic portion 201 provides unpredictable and reactive motion of the hanging toy 200 that encourages further play and more stimulation for the animal.

The device 10 magnets are provided in a specific alignment of polarities (i.e., normal and reverse; and/or north and south polarities) to enable the life-like movement of the hanging toy 200. Accordingly, the edge magnets 131 and the center magnet 132 are selected with opposite polarities with this polarity aligned towards the top portion 102 for interaction with the hanging toy 200. The hanging toy 200 magnetic portion 201 also having a specifically aligned polarity for interaction with the edge magnets 131 and the center magnet 132, wherein the magnetic portion 201 magnetic polarity is aligned with the lowest portion of the hanging toy 200 to be directed towards the lower floor 103 and comprised of a like magnetic polarity when compared with the center magnet 132, wherein the center magnet 132 and the hanging toy 200 magnetic portion 201 repel each other due to the similar alignment of their magnetic polarity. Accordingly, the magnetic portion 201 of the hanging toy 200 and the edge magnets 131 are comprised of a dissimilar magnetic polarity, wherein the hanging toy 200 is attracted towards the edge of the lower floor 103 and repelled from the center area of the lower floor 103.

Furthermore, the edge magnets 131 may be paced within cavities in the lower floor 103 rendering the edge magnets 131 capable of slight movement and adjustment within their respective cavity to allow for erratic movement and customization of the magnetic forces interacting on the hanging toy 200 magnetic portion 201, creating life-like and substantially prolonged three-dimensional movements of the hanging toy 200. To facilitate this magnetic interaction, it is preferred that the length of the hanging toy 200 be generally based upon the size of the device 10, so as to allow the hanging toy 200 to dangle at a fixed position slightly above the lower floor 103, but not in contact with the lower floor 103.

In an embodiment of the present disclosure, the device 10 is generally arranged in a cube shape having four sidewalls defining four corners of device 10. The four corners of the device 10 cube shape allowing for the placement of the edge magnets 131 into the corners, wherein the device lower floor 103 will have a first edge magnet 1311, a second edge magnet 1312, a third edge magnet 1313, and a fourth edge magnet 1314 all with the same polarity. The device 10 will include the center magnet 132 and the magnetic portion 201 of the hanging toy 200 also having a like polarity opposite the edge magnets 131, wherein the hanging toy 200 will be attracted towards the edges of the cube shaped device 10 and be repelled from the center of the lower floor 103 due to the presence of the like polarity of the center magnet 132. In this preferred cube shaped embodiment, the device 10 housing 100 is constructed from transparent or translucent plastic to allow for sight into the interior space 101. Accordingly, this cube shaped device 10 will have at least four apertures 1401, 1402, 1403, 1404, of the plurality of apertures 140 with each aperture of the at least four apertures 1401, 1402, 1403, 1404 positioned on each side of the cube shape housing 100. Generally, the cubic housing 100 of the preferred embodiment of the device 10 is construed in a size corresponding to the anatomy of a typical house cat, wherein the typical length of a house cat appendage is twelve inches (12 in.). Accordingly, to accommodate this anatomical size, the cube shaped housing 100 has a side length of about twelve inches (12 in.) and the hanging toy 200 is configured to hang in the center of the interior space 101 above the center magnet 132 and located about six inches (6 in.) distance from each aperture 1401, 1402, 1403, 1404, of the plurality of apertures 140, wherein a cat would easily be able to reach and contact the hanging toy 200 by manipulating a paw or paws through an aperture of the plurality of apertures 140 and into the interior space 101 of the housing 100 to direct movement of the hanging toy 200.

The hanging toy 200 of the device 10 is generally provided in an assembly that allows for fastening to an underside of the top portion 102, wherein the hanging toy 200 can be easily removed and/or swapped out for another hanging toy 200. Accordingly, the hanging toy 200 may be made of different materials and have various themes or constructions. In one embodiment of the present disclosure, the hanging toy 200 has an orb-like pendant shape having a plurality of openings and is configured to receive and hold items within an interior, such as, but not limited to, treats, attractants (catnip), or objects that may be retrieved by an animal during use. Alternately, the hanging toy 200 may be a plush item made of various materials and having various textures and shapes to mimic another animal or creature that is consistent with a theme of the device 10 or desired by an animal. In yet another embodiment, the hanging toy 200 is generally comprised of the pendant shape but with a specific orientation of the plurality of openings and sizes of the plurality of openings, wherein the hanging toy 200 can include segmented compartments with different sized openings to allow for certain items to remain retained within the hanging toy 200 to provide a scent while allowing for the release of certain other items or treats from larger openings. Accordingly, the hanging toy 200 can be utilized as reward system for the animal interacting with the device 10, wherein the animal will be encouraged to interact with the device 10 and hanging toy 200 due to the presence of the reward.

The hanging toy 200 may be coupled to top portion 102 underside through a fastener, such as, but not limited to, a swivel 202 coupling that allows for rotation of the hanging toy 200 during use. The swivel 202 generally having a clasp portion that can be coupled to a ring or aperture (not pictured) on the underside of the top portion 102, wherein the hanging toy can be easily removed and affixed for interchangeability with the top portion 102. The hanging toy includes a line/wire portion 203 generally extending between the swivel 202 and the hanging toy 200 with a length of the line/wire portion defining the dangling position of the magnetic portion 201 relative to the magnets positioned within the lower floor 103. The line/wire portion can be comprised of a multitude of materials, including, but not limited to, wire, string, twine, cable, monofilament, elastics, or other similar materials. Preferably, the line/wire 203 portion is comprised of a monofilament, such as a fish line, due to its inherent transparency, strength, and durability. Additionally, the line/wire portion may be configured to allow for adjustment to the dangling length of the hanging toy 200 and inherently facilitating erratic and substantially prolonged three-dimensional movements of the hanging toy 200.

The housing 100 lower floor 103 may additionally include a plurality of non-slip feet 133 generally positioned at an exterior surface of the lower floor 103 opposite the interior space 101. The feet 133 are generally provided to provide increased friction relative to the surface the device 10 is placed upon to aid in supporting and preventing movement of the device 10 during use and interaction. The non-slip feet 133 may be placed at the corners of the housing 100 and provided in a material that presents a tacky or non-slip surface. Accordingly, the materials of the non-slip feet may include, but not be limited to, rubbers, silicones, plastics, and other similar materials.

The device 10 utilizing a plurality of magnets within the structure. To enable the life-like movement of the hanging toy 200, it is preferred that the magnetic force of the magnets be maximized relative to their size to facilitate the movement. Accordingly, it is preferred that these magnets 131, 132, 201 are of the rare-earth type comprised of neodymium or samarium-cobalt to maximize the magnetic field relative to their size. Although, these rare-earth type magnets are preferred, the magnets 131, 132, 201 could be comprised of ferrite, alnico, or electromagnets provided they present a magnetic field capable of facilitating the life-like movement of the hanging toy 200.

The device 10 perpetual functionality provided by the assisted movement from magnetic forces onto the magnetic hanging toy 200. This apparatus fulfills the need for a self-powered cat toy configured to direct movement of an article without the use of a power source, wherein the effect of the magnets, 131, 132, 201 provides unpredictable and reactive motion of the hanging toy 200 that encourages further play and more stimulation for the cat during use.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. An interactive toy for a pet, the toy comprising:
a housing, the housing defining an interior space and having a plurality of openings into the interior space, the housing including a lower surface with a plurality of embedded magnets; and
a hanging toy, the hanging toy configured for hanging into the interior space and including a magnetic portion, the magnetic portion having a polarity selected for interaction with the plurality of embedded magnets, wherein movement of the hanging toy is facilitated by the interaction between the magnetic portion and the plurality of embedded magnets.

2. The toy of claim 1, further comprising a removable top portion, wherein the removable top portion is equipped with a carrying handle and the hanging toy.

3. The toy of claim 2, wherein the hanging toy is coupled to the removable top portion by a swivel and a line/wire.

4. The toy of claim 1, wherein the housing is a cube shaped housing.

5. The toy of claim 4, wherein the cube shaped housing contains at least four apertures within a sidewall of the toy with one aperture on each side of the housing.

6. The toy of claim 1, further comprising a plurality of non-slip feet positioned underneath the lower surface.

7. The toy of claim 1, wherein the housing is made of a transparent material.

8. The toy of claim 1, wherein the hanging toy is interchangeable.

9. The toy of claim 1, wherein the magnetic portion has a polarity selected for attraction to a plurality of edge magnets of the embedded magnets.

10. The toy of claim 1, wherein the plurality of apertures are sized for the receipt of a paw from a cat, wherein the cat may move their paw into the interior space of the housing to direct movement of the hanging toy.

11. An interactive toy for an animal, the toy comprising:
a cube shaped housing, the housing defining an interior space and having at least four apertures into the interior space, the cube shaped housing including a lower surface with a center magnet placed in a center of the lower surface and a plurality of edge magnets positioned adjacent to a corner of the lower surface, wherein each corner of the cube shaped housing includes an edge magnet of the plurality of edge magnets;
a hanging toy, the hanging toy having a magnetic portion and configured for hanging into the interior space, wherein the magnetic portion and the center magnet are selected to have like polarity to repel from each other and the plurality of edge magnets are selected to have opposite polarity to that of the magnetic portion and the center magnet to attract the magnetic portion, and
wherein movement of the hanging toy is facilitated by the interaction between the center magnet, plurality of edge magnets, and the magnetic portion.

12. The toy of claim 11, wherein the edge magnets are paced within a cavity in the lower surface and capable of movement within their respective cavity.

13. The toy of claim 11, wherein the cube shaped housing has a side length of about 12 inches and the hanging toy is configured to hang in the center of the interior space.

14. The toy of claim 11, wherein the housing is transparent.

15. The toy of claim 11, wherein the housing includes a top portion, the top portion being removable.

16. The toy of claim 15, wherein the hanging toy is removably secured to the top portion.

17. The toy of claim 11, wherein the hanging toy is configured to receive items within an interior of the hanging toy.
